(19) United States
(12) Patent Application Publication
(10) Pub. No.: US 2008/0208377 A1
(43) Pub. Date: Aug. 28, 2008

(54) UNIVERSAL AUDIO INTERFACE APPARATUS AND AUDIO PROCESSING DEVICE USING THE SAME

(75) Inventors: DE-ZHI LI, Shenzhen (CN); YU-ZHANG WEN, Shenzhen (CN); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/942,723

(22) Filed: Nov. 20, 2007

(30) Foreign Application Priority Data
Feb. 28, 2007 (CN) 200710073414.7

(51) Int. Cl. G06F 17/00

(52) U.S. Cl. 700/94

(57) ABSTRACT

A universal audio interface apparatus includes one input/output circuit comprising an input/output interface and a switch unit; an interface control module for monitoring the input/output interface, detecting whether the input/output interface is coupled with an external audio input device or an external audio output device, and sending predetermined display signals for prompting a device selection input that indicates if the input/output interface is coupled with the external audio input device or the external audio output device; and a user interface module for displaying a selection menu consisting of selectable icons of the external audio input device and the external audio output device according to the predetermined display signals, after one of the selectable icons being selected, the interface control module controls the switch unit to connect an input/output port of the input/output circuit to an internal speaker or a signal generation module.

### BACKGROUND OF THE INVENTION

1. Field of the Invention

The present invention relates to audio interfaces and audio processing devices using the same, and especially to a universal audio interface apparatus and an audio processing device using the same.

2. Description of Related Art

An audio processing device has at least one audio input interface such as a line-in interface or a microphone interface, and at least one audio output interface such as a line out interface or a speaker interface. As an example, the audio processing device may be a computer with audio processing software or a portable audio player. The line-in interface is configured for connecting to an external audio signal source, for receiving audio signals from the external audio signal source. The microphone interface is configured for connecting to a microphone, for receiving audio signals from the microphone. The line out interface is configured for connecting to an active speaker, for outputting audio signals generated by the audio processing device to the active speaker. The speaker interface is configured for connecting to a passive speaker, for outputting audio signals generated by the audio processing device to the passive speaker.

Referring to FIG. 4, the computer generally has three audio interfaces including a line in interface, a line out interface and a microphone interface. When a user wants to insert an earphone plug or a speaker plug to a corresponding audio interface, error is often been made.

Therefore, a heretofore unaddressed need exists in the industry to overcome the aforementioned deficiencies and inadequacies.

### SUMMARY OF THE INVENTION

A universal audio interface apparatus and an audio processing device using the same are provided.

The universal audio interface apparatus includes at least one input/output circuit, an interface control module, and a user interface module. Each input/output circuit includes an input/output interface and a switch unit electrically connected to each other. The interface control module is electrically connected to the input/output interface and the switch unit of each of the input/output circuits, for monitoring the input/output interface of each of the input/output circuits, detecting whether the input/output interface of one of the input/output circuits is coupled with an external audio input device or an external audio output device, and sending predetermined display signals for prompting a device selection input that indicates if the input/output interface of the one of the input/output circuits is coupled with the external audio input device or the external audio output device. The user interface module displays a selection menu consisting of selectable icons of the external audio input device and the external audio output device according to the predetermined display signals. After one of the selectable icons is selected to indicate which one of the external audio input device and the external audio output device is coupled to the input/output interface, the interface control module controls the switch unit of the one of the input/output circuits to connect an input/output port of the one of the input/output circuits to an internal speaker or a signal generation module.

Other devices, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a block diagram of a hardware infrastructure of an audio processing device of the present invention.

FIG. 2 is a block diagram of a hardware infrastructure of the audio processing device in accordance with an exemplary embodiment of the present invention.

FIG. 3 is a block diagram of a hardware infrastructure of the audio processing device in accordance with an alternative embodiment of the present invention.

FIG. 4 is a back schematic view of a common audio processing device.

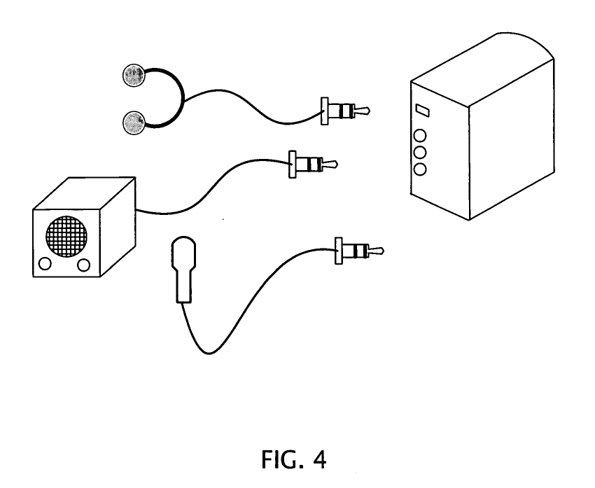

### DETAILED DESCRIPTION OF THE INVENTION

The present features and functions involve a universal audio interface apparatus that can be incorporated in an audio processing device such as a portable media player or a computer with audio playing software. The following detailed description of exemplary embodiments is made with reference to the attached drawings.

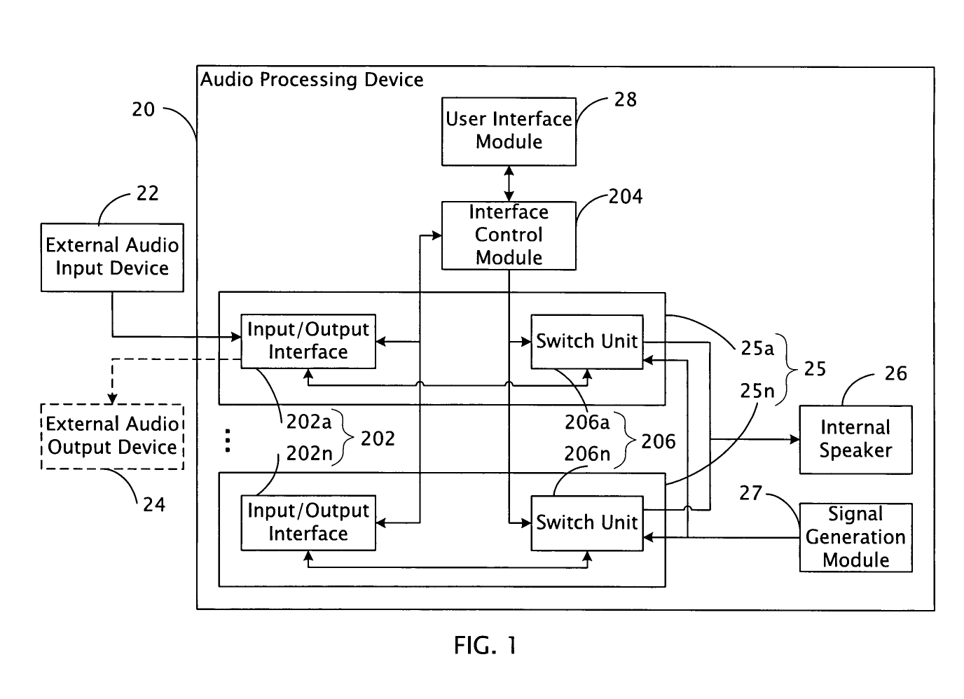

FIG. 1 is a block diagram of a hardware infrastructure of an audio processing device 20. The audio processing device 20 includes a signal generation module 27, at least one input/output circuit 25, an interface control module 204, a user interface module 28, and at least one internal transducer such as an internal speaker 26. Each input/output circuit 25 is electrically connected to the internal speaker 26 and the signal generation module 27. The number of the input/output circuits 25 can be one or more, such as 25a, . . . , 25n, and properly one or two. The internal speaker 26 is used for receiving audio signals that the user interface module 28 receives from an external audio input device 22 via one of the input/output circuits 25, and outputting sounds corresponding to the audio signals. The external audio input device 22 can be a microphone or an external audio signal source. The signal generation module 27 is used for processing an audio file, and generating audio signals that are outputted to an external audio output device 24 via one of the input/output circuits 25. The external audio output device 24 can be an earphone or an external speaker. The user interface module 28 is electrically connected to the input/output circuits 25.

Each of the input/output circuits 25 shares the interface control module 204 and includes an input/output interface 202 and a switch unit 206. The input/output interface 202 and the switch unit 206 of each of the input/output circuits 25 are electrically connected to the interface control module 204. The switch unit 206 of each of the input/output circuits 25 connects the internal speaker 26 to the input/output interface 202, and connects the signal generation module 27 to the input/output interface 202.

The interface control module 204 is used for monitoring the input/output interface 202 of each of the input/output circuits 25, detecting whether the input/output interface 202 of one of the input/output circuits 25 is coupled with the external audio input device 22 or the external audio output device 24. For example, when the input/output interface 202 of the input/output circuit 25a is coupled to the external audio input device 22 or the external audio output device 24, the input/output interface 202 generates a detection signal, and sends the detection signal to the interface control module 204 for responding the detection signal. The interface control module 204 receives the detection signal from the input/output interface 202, and sends predetermined display signals to the user interface module 28. The predetermined display signals are configured for prompting a device selection input that indicates if the input/output interface 202 is coupled with the external audio input device 22 or the external audio output device 24.

The user interface module 28 receives the predetermined display signals, and displays a selection menu consisting of selectable icons of the external audio input device 22 and the external audio output device 24 according to the predetermined display signals. After one of the selectable icons is selected to indicate which one of the external audio input device 22 and the external audio output device 24 is coupled to the input/output interface 202, the user interface module 28 generates a command signal corresponding to the one of the selectable icon.

The interface control module 204 receives the command signal, and controls the switch unit 206 of the input/output circuit 25a to connect the input/output port of the input/output circuit 25a to the internal speaker 26 or the signal generation module 27. That is, if the input/output interface 202 is coupled with the external audio input device 22 and the selectable icon of the external audio input device 22 is selected, the interface control module 204 controls the switch unit 206 to establish the connection of the internal speaker 26 with the input/output interface 202, and if the input/output interface 202 is coupled with the external audio output device 24 and the selectable icon of the external audio output device 24 is selected, the interface control module 204 controls the switch unit 206 to establish the connection of the signal generation module 27 with the input/output interface 202.

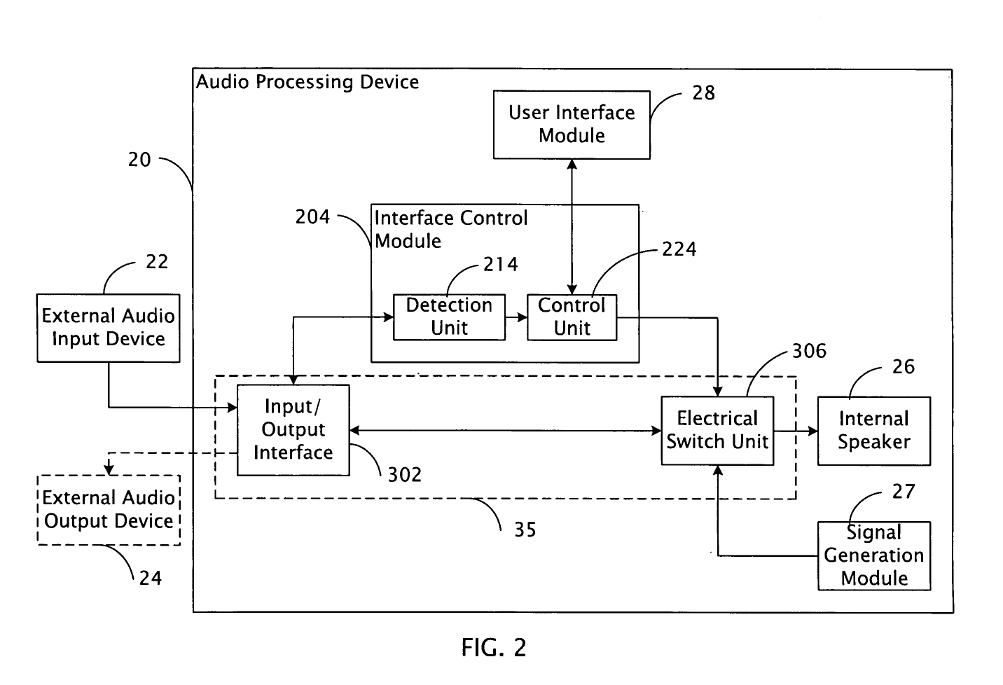

FIG. 2 is a block diagram of a hardware infrastructure of the audio processing device 20 in accordance with an exemplary embodiment. In this exemplary embodiment, the audio processing device 20 includes one input/output circuit 35 and an interface control module 204. The input/output circuit 35 includes an input/output interface 302 and a switch unit 306. The switch unit 306 is illustratively an electrical switch unit. The electrical switch unit 306 electrically connects the input/output interface 302 to the internal speaker 26 or the signal generation module 27.

The interface control module 204 includes a detection unit 214 and a control unit 224. The detection unit 214 detects voltages at the input/output interface 302, generates a detection signal indicating a voltage change at the input/output interface 302 when either of the external audio input device 22 and the external audio output device 24 is coupled to the input/output interface 302, and sends the detection signal to the control unit 224.

The control unit 224 receives the detection signal from the detection unit 214, and sends the predetermined display signals to the user interface module 28. The predetermined display signals are configured for indicating if the input/output interface 302 is coupled with the external audio input device 22 or with the external audio output device 24. The user interface module 28 receives the predetermined display signals, and displays a selection menu consisting of selectable icons of the external audio input device 22 and the external audio output device 24.

After one of the selectable icons is selected to indicate which one of the external audio input device 22 and the external audio output device 24 is coupled to the input/output interface 302, the user interface module 28 receives the one of the selectable icon, and generates a command signal corresponding to the one of the selectable icon.

The control unit 224 receives the command signal, and controls the switch unit 306 of the input/output circuit 35 to connect the input/output port of the input/output circuit 35 to connect to the internal speaker 26 or the signal generation module 27. That is, if the input/output interface 302 is coupled with the external audio input device 22 and the selectable icon of the external audio input device 22 is selected, the control unit 224 controls the switch unit 306 to establish the connection of the internal speaker 26 with the input/output interface 302, and if the input/output interface 302 is coupled with the external audio output device 24 and the selectable icon of the external audio output device 24 is selected, the control unit 224 controls the switch unit 306 to establish the connection of the signal generation module 27 with the input/output interface 302.

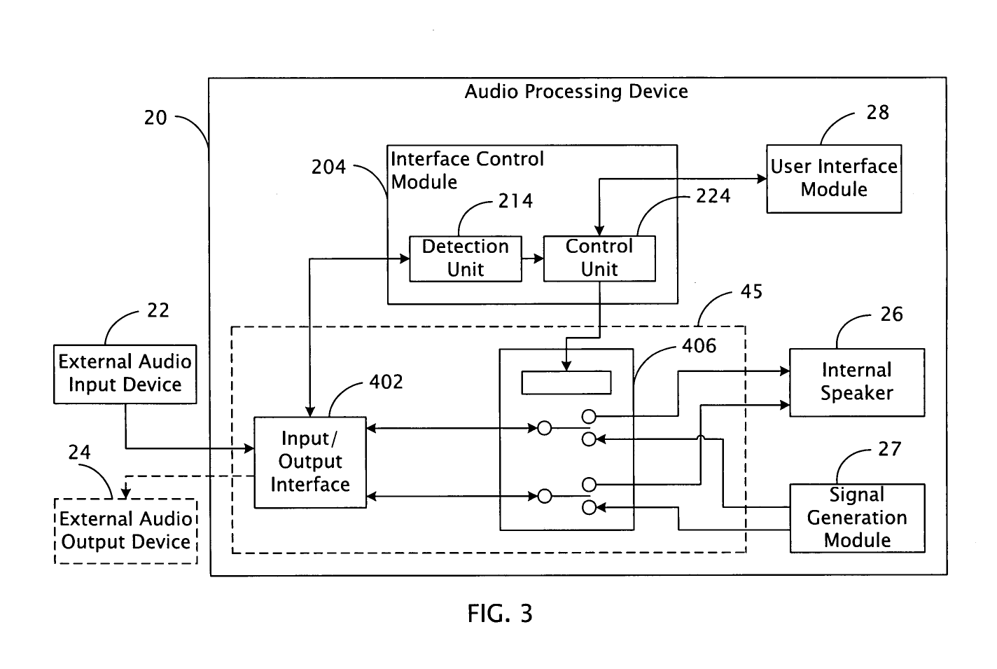

FIG. 3 is a block diagram of a hardware infrastructure of the audio processing device 20 in accordance with an alternative embodiment. In this alternative embodiment, the input/output circuits 45 is the same as that of the exemplary embodiment, except that the switch unit is illustratively a relay unit 406 and the input/output interface 402 is adopted to connect the relay unit 406. Under the control of the control unit 224, the relay unit 406 mechanically establish the connection of corresponding one of the internal speaker 26 and the signal generation module 27 with the external audio input device 22 or the external audio output device 24 that is coupled to the input/output interface 402. That is, if the input/output interface 402 is coupled with the external audio input device 22 and the selectable icon of the external audio input device 22 is selected, the control unit 224 controls the electrical switch unit 406 to establish the connection of the internal speaker 26 with the input/output interface 402, and if the input/output interface 402 is coupled with the external audio output device 24 and the selectable icon of the external audio output device 24 is selected, the control unit 224 controls the switch unit 406 to establish the connection of the signal generation module 27 with the input/output interface 402.

It is understood that the invention may be embodied in various other forms without departing from the spirit thereof. Thus, the present examples and embodiments are to be considered in all respects as illustrative and not restrictive, and the invention is not to be limited to the details given above.

What is claimed is:

1. A universal audio interface apparatus comprising:
at least one input/output circuit, each input/output circuit comprising an input/output interface and a switch unit electrically connected to each other, each input/output interface configured for being coupled with an external audio input device or an external audio output device;
an interface control module electrically connected to the input/output interface and the switch unit of each of the input/output circuits, for monitoring the input/output interface of each of the input/output circuits, detecting whether the input/output interface of one of the input/output circuits is coupled with the external audio input device or the external audio output device, and sending predetermined display signals for prompting a device selection input that indicates if the input/output interface of the one of the input/output circuits is coupled with the external audio input device or the external audio output device; and
a user interface module for receiving the predetermined display signals, and displaying a selection menu consisting of selectable icons of the external audio input device and the external audio output device, after one of the selectable icons being selected to indicate which one of the external audio input device and the external audio output device being coupled to the input/output interface, the interface control module controlling the switch unit of the one of the input/output circuits to connect an input/output port of the one of the input/output circuits to an internal speaker or a signal generation module.

2. The universal audio interface apparatus according to claim 1, wherein the interface control module comprises:
a detection unit for detecting voltages of the input/output interface, and generating a detection signal indicating a voltage change at the input/output interface when either of the external audio input device and the external audio output device is coupled to the input/output interface; and
a control unit for receiving the detection signal, sending the predetermined display signals to the user interface module, and controlling the switch unit of the one of the input/output circuits to connect the input/output port of the one of the input/output circuits to the internal speaker or the signal generation module when a command signal is received.

3. The universal audio interface apparatus according to claim 1, wherein the switch unit is an electrical switch unit which is controlled to electrically connect the input/output port of the one of the input/output circuits to the internal speaker or the signal generation module.

4. The universal audio interface apparatus according to claim 1, wherein the switch unit is a relay unit which is controlled to mechanically connect the input/output port of the one of the input/output circuits to the internal speaker or the signal generation module.

5. The universal audio interface apparatus according to claim 1, wherein the number of input/output circuits is one or two.

6. An audio processing device comprising:
an internal speaker for outputting sounds;
a signal generation module for processing an audio file, thus generating audio signals according to the audio file; and
at least one input/output circuit, each input/output circuit comprising an input/output interface and a switch unit electrically connected to each other, each input/output interface configured for being coupled with an external audio input device or an external audio output device;
an interface control module electrically connected to the input/output interface and the switch unit of each of the input/output circuits, for monitoring the input/output interface of each of the input/output circuits, detecting whether the input/output interface of one of the input/output circuits is coupled with the external audio input device or the external audio output device, and sending predetermined display signals for prompting a device selection input that indicates if the input/output interface of the one of the input/output circuits is coupled with the external audio input device or the external audio output device; and
a user interface module for receiving the predetermined display signals, and displaying a selection menu consisting of selectable icons of the external audio input device and the external audio output device according to the predetermined display signals, after one of the selectable icons being selected to indicate which one of the external audio input device and the external audio output device being coupled to the input/output interface, the interface control module controlling the switch unit of the one of the input/output circuits to connect an input/output port of the one of the input/output circuits to the internal speaker or the signal generation module.

7. The audio processing device according to claim 6, wherein the interface control module comprises:
a detection unit for detecting voltages of the input/output interface, and generating a detection signal indicating a voltage change at the input/output interface when either of the external audio input device and the external audio output device is coupled to the input/output interface; and
a control unit for receiving the detection signal, sending the predetermined display signals to the user interface module, and controlling the switch unit of the one of the input/output circuits to connect the input/output port of the one of the input/output circuits to the internal speaker or the signal generation module when a command signal is received.

8. The audio processing device according to claim 6, wherein the switch unit is an electrical switch unit which is controlled to electrically connect the input/output port of the one of the input/output circuits to the internal speaker or the signal generation module.

9. The audio processing device according to claim 6, wherein the switch unit is a relay unit which is controlled to mechanically connect the input/output port of the one of the input/output circuits to the internal speaker or the signal generation module.

10. The audio processing device according to claim 6, wherein the number of the input/output circuits is one or two.
